(19) United States
(12) Patent Application Publication
(10) Pub. No.: US 2018/0100646 A1
(43) Pub. Date: Apr. 12, 2018

(54) GROUND ILLUMINATION DEVICE

(71) Applicant: Edward SULLIVAN, Philadelphia, PA (US)

(72) Inventor: Edward SULLIVAN, Philadelphia, PA (US)

(21) Appl. No.: 15/726,444

(22) Filed: Oct. 6, 2017

Related U.S. Application Data
(60) Provisional application No. 62/405,477, filed on Oct. 7, 2016.

(51) Int. Cl. F21V 33/00; F21V 23/00; F21S 9/02; F21V 23/04; A41F 9/00

(52) U.S. Cl. CPC F21V 33/0008; F21V 23/001; F21Y 2115/10; F21V 23/0471; A41F 9/002; F21S 9/02

(57) ABSTRACT

A ground illumination device for providing a human user with the ability to continuously illuminate a 360-degree area of ground surrounding the user while retaining use of the user's hands is disclosed. The ground illumination device includes a harness having a center cavity, an inner chamber, an outer surface, and a circumference, an attachment mechanism disposed within the inner chamber extending along the circumference to secure the ground illumination device to the user; a power source attached to the harness; a plurality of light sources disposed on the outer surface, and a plurality of wires, disposed within the inner chamber, extending from the power source to the plurality of light sources. Preferably the plurality of light sources are configured to illuminate the 360-degree area of ground surrounding the user and are evenly spaced around the circumference of the harness.

### CLAIM OF PRIORITY

This application is a non-provisional utility application of provisional patent application, Ser. No. 62/405,477 filed in the United States Patent Office on Oct. 7, 2016, which claims priority therefrom, and is expressly incorporated herein by reference in its entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present disclosure relates to a ground illumination device. More particularly, the present disclosure relates to a ground illumination device worn around a user's waist that is capable of illuminating a 360-degree area of ground around the user.

### BACKGROUND

The benefits of running are well-known today, as there are no shortages of articles, books, motivational videos, and the like that encourage members of the public to go running. While many professions allow people to take breaks during the day, or afford them a flexible enough schedule that they can make time to exercise during daylight hours, many Americans and other citizens of the world are unable to make time to exercise during the day. Without being able to run outside during the day, these people are left with two choices: running on an indoor treadmill; or braving the dangers of running at night.

There are two primary hazards of running at night. The first is being struck by a vehicle that does not see the runner due to poor lighting. The other danger is the inability of the runner to see their surroundings. These problems are conflated by the fact that many runners like to listen to music while running, which impairs their senses. Additionally, many runners choose to run on trails or other non-paved surfaces, making the need to clearly see their surroundings paramount.

Regarding the first issue, that runners need a way to illuminate themselves such that vehicles can see them in lowlight conditions, many solutions exist. These include things such as reflective clothing and articles that provide enough light to be seen, but not illuminate the ground below. For the second hazard, solutions also exist where a single light is used to illuminate a path in front of the user. However, those solutions fail to illuminate a large portion of the ground surrounding the wearer, making any kind of lateral movement impossible, as the wearer must be facing the direction they would like to illuminate. As such, there exists a need for a device that is capable of illuminating a 360-degree area of ground around a user without the user needing to hold the device with their hands. Note that such a device would have uses aside from running, as anyone who needs to navigate non-paved ground at night, while retaining the use of their hands, could benefit from the use of this device.

### REVIEW OF RELATED TECHNOLOGY

U.S. Pat. No. 8,845,122 pertains to a person's wardrobe for use in entertainment, and, in particular, on stage venues for projection of laser light from a person's body that is par to the pyrotechnic prior art for the large space of stage entertainment. The above system provides a unique small visual entertainment system that operates on batteries to enable the individual to walk about a large stage area which can entertain an audience.

U.S. Pat. No. 7,185,997 pertains to a method and apparatus for illuminating the area in front of a person without requiring the use of the person's hands, by suspending from the neck of the person a housing containing at least one LED light source emitting a light beam extending forwardly from the person, a battery power supply for the light source, and a switch connected between the light source and the power supply for energizing and de-energizing the light source. The housing is shaped to rest against the chest of the person so that the direction of the light beam remains substantially stable. The housing may be pivotable relative to a connector to permit the light beam from the light source to be directed forwardly from the person through a preselected range of angles both above and below a horizontal axis.

U.S. Pat. No. 6,056,412 pertains to a waist mounted illuminating device comprised of a belt having a length sufficient to fit around a person's waist. A compartment comprised of flexible material is located on the belt. The compartment has an opening. A battery operated light having an illuminable face is disposed in the compartment and directs light through the opening in the compartment. The compartment and belt may be formed of a flexible material such as neoprene. When the belt is firmly adjusted around a user's waist, the compartment and belt firmly and steadily maintain the battery operated light on the user's waist, even while the user is running or jogging. This stable mount of the light to the waist provides steady illumination of the user's path for general illumination and for exercise activities such as running or jogging.

U.S. Pat. No. 5,879,076 pertains to a method and apparatus for light transmission adapted for use in a reflective belt, safety vest, or similar devices requiring visibility of a bright and/or reflective material where a light source of one or more lighting elements is positioned to transmit light along a self-supporting elongated light transmitting member of a hot-melt adhesive thermoplastic material and a flashing circuit for the light source which includes a battery pack or any other power source convertible to D.C. voltage. The hot-melt adhesive is of a high clarity, highly flexible material which transmits light in a highly visible manner within an elongated casement of material formed of a light-colored backing material and a front strip of a translucent material adapted to transmit the light driven along the member by the light-emitting source. Any light-emitting source, either visible or invisible would be suitable for the transmitting device. Similarly, the casement of material, elongated members, light-emitting sources and circuit and D.C. power source could be mounted on either the front and/or rear panel of a safety vest where the vest is desirable for high visibility in darkness or dimly lit situations.

U.S. Pat. No. 5,535,106 pertains to an animal collar includes an elongate strap and electrical light emitting and reflecting devices individually attached to the strap at spaced intervals therealong. Each of the light emitting and reflecting devices includes a housing with a base and a cover formed of a translucent, light reflective material and attachable to the base to enclose an interior containing a light emitting diode, electric conductors, a battery and a switch to operate the light emitting diode between and on and off condition. Threaded attachment members removably secure each of the light emitting and reflecting devices to an upper surface of the strap.

U.S. Pat. No. 5,245,516 pertains to a portable illumination device provided by a combination of an elongated carrier, a source for electrical power mounted on the carrier, and a substantially planar light sources couples to the source for electrical power and mounted on the carrier in a coplanar manner.

U.S. Pat. No. 5,140,946 pertains to an illuminable pet collar including a housing for a battery power source and an elongated, flexible, pliable, transparent plastic display tube having a plurality of spaced apart miniature lights operably connected therewithin and along substantially the entire length of the display tube. The housing includes a stem or extension tube extending from each end thereof sized to be snugly inserted into each end of the display tube. Electrical connection between the battery and the outer surface of one stem communicates electrical power to the lights which are parallel-wired within the display tube.

U.S. Pat. No. 4,812,953 pertains to safety light band maximizes visibility of a pedestrian wearing the band in poorly lighted or unlighted conditions. The band is formed as a flexible strap having fastening means for wearing the band on the person, and luminous means comprising an interactive combination of electric lamps and reflective surfaces.

U.S. Pat. No. 4,652,981 pertains to an illuminatable belt is described which includes a two piece buckle, a power pack and an elongated tube connected to one piece of the buckle at one end and to the second piece of the buckle at the opposite end. The power pack contains battery operated flashlight type circuitry with an on-off switch, and a bulb is connected to the circuit. A bundle of optical fibers extends from the bulb area into the hollow tube away from the bulb. When the power pack contains batteries and is turned on, light shines away from the power pack into the fiber bundle so as to illuminate the hollow tube, e.g., throughout the entire length of the belt.

U.S. Pat. No. 4,523,258 pertains to a flexible safety belt which may be easily worn about the waist of a pedestrian or runner is disclosed. The belt includes an arrangement for fastening the ends together and a plurality of light-emitting diodes disposed along the outer surface of the belt. A pair of oscillators having distinct different frequencies are connected to each of a respective pair of nodes between which all of the diodes are connected. The diodes are connected so that the lower frequency oscillator conditions a set of diodes to be flashed by the output of the higher frequency oscillator when the low frequency oscillator is in one state and the balance of the diodes to be flashed by the high frequency oscillator when the lower frequency oscillator output is in the opposite state. The electronic circuitry is all constructed on a flexible circuit board disposed within the hollow interior of the belt, with the circuitry also preferably including a separately controllable alarm means.

U.S. Pat. No. 4,283,756 pertains to a belt which includes the usual flexible strip and buckle. Flashing-light means is mounted in the buckle and is powered by a portable supply which may be located in the wearer's pocket. Preferably the light means takes the form of two associated flasher circuits.

U.S. Pat. No. 3,641,333 pertains to a flexible tubular belt of a generally translucent material adapted to carry an electromotive force power pack for connection to a plurality of light bulbs within the belt and the belt having a magnetic coupling which performs the dual function of holding the ends of the belt together and completing the electrical circuit to cause illumination of the bulbs within the belt.

U.S. Pat. No. 3,134,548 pertains to a flexible tubular belt of a generally translucent material adapted to carry an electromotive force power pack for connection to a plurality of light bulbs within the belt and the belt having a magnetic coupling which performs the dual function of holding the ends of the belt together and completing the electrical circuit to cause illumination of the bulbs within the belt.

United States Patent Publication No.: 2007/0107672 pertains to a 360° multi-directional long distance lighted safety harness for a canine provides maximum visibility of a canine within approximately half mile radius. This is achieved by two battery operated multi-LED light units secured to a canine harness so that when the harness is positioned on the canine, one light unit is positioned on one side of the canine and the other light unit is positioned on the opposite side of the canine. When positioned, the light units protrude from the body of the canine.

European Patent Document No.: EP1090252 pertains to a method and apparatus for light transmission adapted for use in a reflective belt, safety vest, or similar devices requiring visibility of a bright and/or reflective material where a light source of one or more lighting elements is positioned to transmit light along a self-supporting elongated light transmitting member of a hot-melt adhesive thermoplastic material and a flashing circuit for the light source which includes a battery pack or any other power source convertible to D.C. voltage. The hot-melt adhesive is of a high clarity, highly flexible material which transmits light in highly visible manner within an elongated casement of material formed of a light-colored backing material and a front strip of translucent material adapted to transmit the light driven along the member by the light-emitting source. Any light-emitting source, either visible or invisible would be suitable for the transmitting device. Similarly, the casement of material, elongated members, light-emitting sources and circuit and D.C. power source could be mounted on either the front and/or rear panel of a safety vest where the vest is desirable for high visibility in darkness or dimly lit situations.

International Patent Application No.: WO9118374 pertains to a visibility air which provides an improved visibility of the object, person, or animal to which it is affixed. A flexible sheet of material is provided with light source means mounted therein such that the material, which may include reflective properties, is visible to onlookers upon the illumination of said light source means. Provision may also be provided for the inclusion therein of an automatic switching mechanism.

While these units may be suitable for the particular purpose employed, or for general use, they would not be as suitable for the purposes of the present disclosure as disclosed hereafter.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

### SUMMARY

An aspect of an example embodiment in the present disclosure is to provide a hands-free means for illuminating a 360-degree area around a user.

Accordingly, the present disclosure describes a ground illumination device, for providing a human user with the ability to continuously illuminate a 360-degree area of ground surrounding the user while retaining use of the user's hands. The ground illumination device includes a harness having a center cavity, an inner chamber, an outer surface, and a circumference, an attachment mechanism disposed within the inner chamber extending along the circumference to secure the ground illumination device to the user. Preferably this is achieved by by applying an equal amount of force towards the center cavity when engaged. The ground illumination device may also include a power source attached to the harness, and will include a plurality of light sources disposed on the outer surface, where the plurality of light sources are configured to illuminate the 360-degree area of ground surrounding the user. Additionally, the plurality of lights are preferably spaced around the circumference to evenly illuminate said 360-degree area. The power source is connected to the plurality of lights via a plurality of wires, which are disposed within the inner chamber and extend from the power source to the plurality of light sources. This provides for electronic communication therebetween. In one preferred embodiment, the attachment mechanism is an elastic band, and in another preferred embodiment the attachment mechanism is a buckle.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE PREFERRED EMBODIMENTS

In the drawings, like elements are depicted by like reference numerals. The drawings are briefly described as follows.

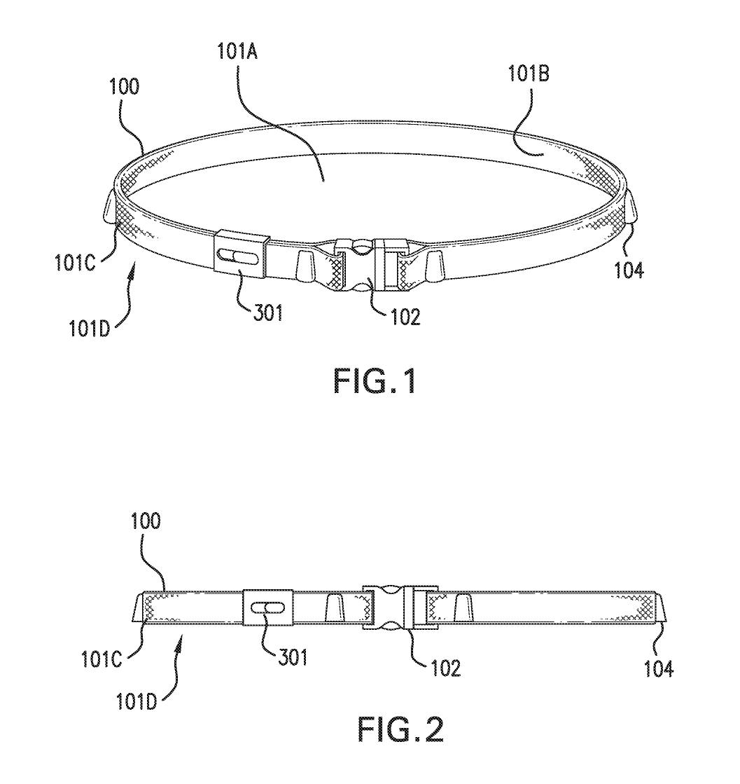

FIG. 1 shows a perspective view of an example embodiment of the ground illumination device according to the present disclosure.

FIG. 2 shows a front view of an example embodiment of the ground illumination device according to the present disclosure.

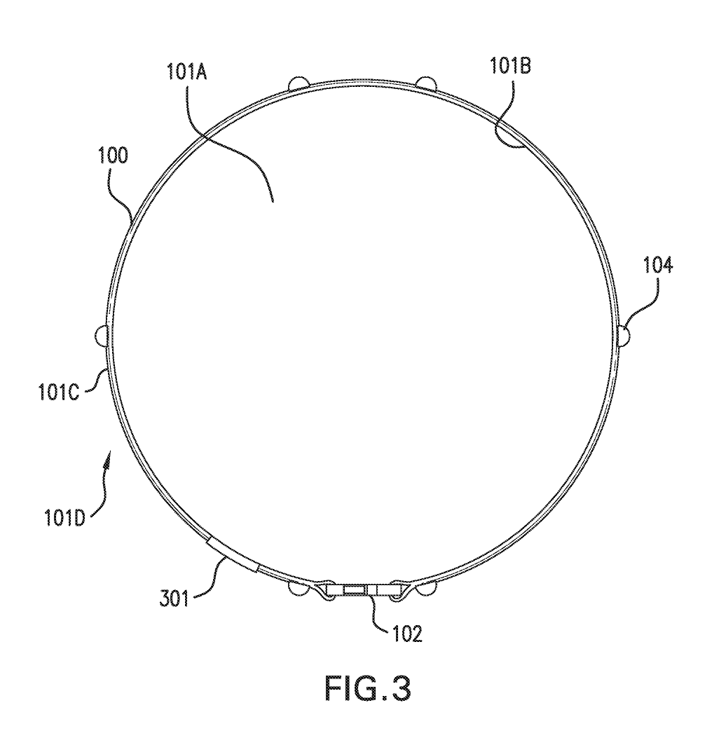

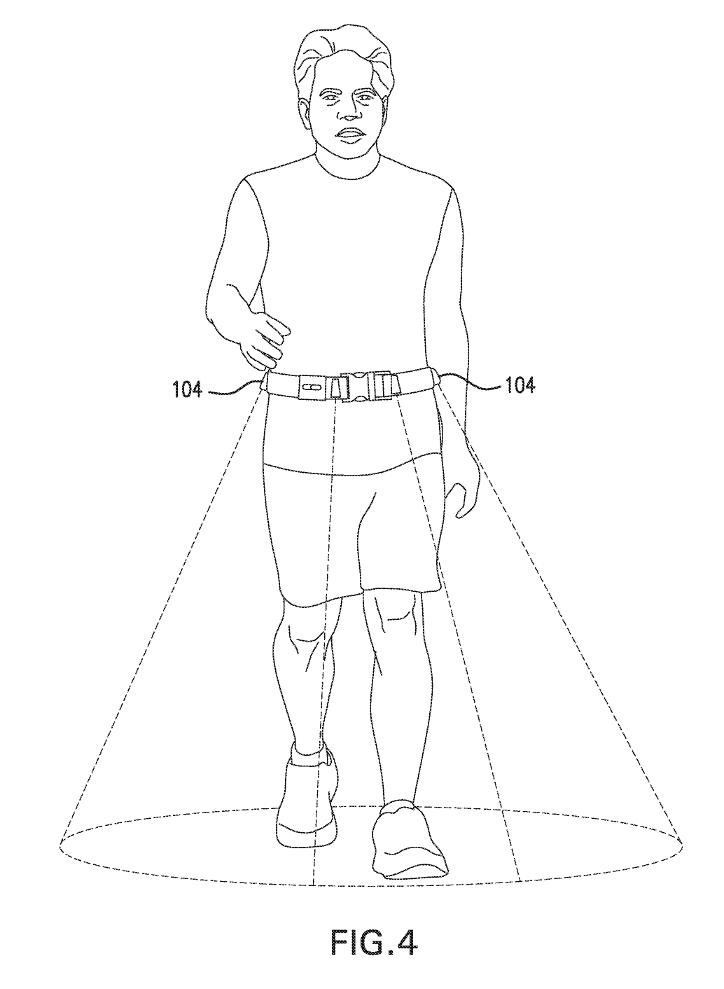

FIG. 3 shows a top view of an example embodiment of the ground illumination device according to the present disclosure.

FIG. 4 shows a front view of an example embodiment of the ground illumination device according to the present disclosure while in use by a human user.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

Referring to FIG. 1, a perspective view of an embodiment of the ground illumination device in accordance to the present invention is shown. Here, the ground illumination device includes a harness 100 which has a center cavity 101A, an inner chamber 101B, an outer surface 101C, and a circumference 101D. The center cavity 101A is sized to receive the waist or torso of a human user, but this size can be varied through changing of the circumference 101D. The ground illumination device also includes an attachment mechanism 102. Here the attachment mechanism 102 is a buckle, which can be used to vary the circumference 101D based on user preference. However, other embodiments exist where the attachment mechanism 102 is an elastic adjustable belt, preferably a one-size-fits-all elastic adjustable belt. Disposed on the outer surface 101C are a plurality of light sources 104. The plurality of light sources 104 are connected by a plurality of wires which are housed in the inner chamber 101B. The ground illumination device includes a power source, which may be mounted within the inner chamber 101B, on the outer surface 101C, or may be mounted somewhere else on the human user. Preferably, the power source is rechargeable, such as a rechargeable lithium-ion battery. Other embodiments exist where the power source is replaceable in addition to being rechargeable. This provides the benefit of quickly swapping in a fully-charged power source instead of having to wait for the power source to charge. The ground illumination device preferably features a power switch 301.

FIGS. 2 and 3 show a front view of an embodiment of the ground illumination device in accordance with the present disclosure. Here, the ground illumination device includes the harness 100. The harness 100 is equipped with the center cavity 101A, has the inner chamber 101B, the outer surface 101C, where the outer surface 101C is equipped with the plurality of light sources 104. The plurality of light sources 104 are configured in such a way that an even distribution of light is made across 360 degrees, on the ground around the wearer. The harness 100 is equipped with the attachment mechanism 102 which is used to fasten the ground illumination device to the wearer.

FIG. 4 shows an example embodiment of the ground illumination device while in use by a human user. Here, the downward projection of light from the plurality of light sources 104 is shown. The configuration of the plurality of lights 104 enables a 360-degree area of ground to be illuminated. This 360-degree area of ground may be a circle, where a user's feet are completely illuminated, or it may be an annulus where a small region in between the user's feet is not illuminated. Both of these configurations have benefits and drawbacks; the circle providing more complete illumination and the annulus being less expensive to construct. The area of the 360-degree area of ground is limited only by the amount of power the power source is capable of delivering, and the luminescence rating of the plurality of light sources. Specifically, the inner radius of the annulus can be as small as 1 inch, and can be as large as 3 feet. Further, the outer radius of the annulus can be as small 1 foot and can be as large as 15 feet. Preferably, the plurality of light sources 104 will be a plurality of LED lights, but other lights such as incandescent light bulbs, and compact fluorescents may also be used.

Alternative embodiments exist where the ground illumination device includes a motion detector which is operatively connected to the power source. Preferably, the motion detector will only allow the power source to operate the plurality of light sources 104 when it detects motion. It should be noted that this configuration of the plurality of light sources 104 shown here is but one embodiment, and that other embodiments exist where there are a different number of the plurality of light sources 104, and where the plurality of light sources 104 are evenly spaced about the circumference 101D. Another preferred embodiment has two front-facing lights, a left-facing light, a right-facing light, and one rear-facing light.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece, or separately fabricated and connected piece.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a ground illumination device. The disclosure is illustrated by example in the drawing figures, and throughout the written description. It should be understood that numerous variations are possible while adhering to the inventive concept. Such variations are contemplated as being a part of the present disclosure.

What is claimed is:

1. A ground illumination device, for providing a human user with the ability to continuously illuminate a 360-degree area of ground surrounding the user while retaining use of the user's hands, the ground illumination device comprising:
a harness having a center cavity, an inner chamber, an outer surface, and a circumference;
an attachment mechanism disposed within the inner chamber extending along the circumference to secure the ground illumination device to the user by applying an equal amount of force towards the center cavity when engaged;
a power source attached to the harness;
a plurality of light sources disposed on the outer surface,
wherein the plurality of light sources are configured to illuminate the 360-degree area of ground surrounding the user and are spaced around the circumference to evenly illuminate said 360-degree area; and
a plurality of wires, disposed within the inner chamber, extending from the power source to the plurality of light sources, providing for electronic communication therebetween.

2. The ground illumination device of claim 1, wherein the attachment mechanism is an elastic band.

3. The ground illumination device of claim 1, wherein the attachment mechanism is a buckle.

4. The ground illumination device of claim 2, wherein the ground illumination device is attached to the waist of the user.

5. The ground illumination device of claim 4, wherein the power source is removably attached to the harness.

6. The ground illumination device of claim 5, wherein the power source is disposed within the inner chamber.

7. The ground illumination device of claim 4, wherein the power source is disposed on the outer surface.

8. The ground illumination device of claim 7, wherein the plurality of light sources are at least five light emitting diodes.

9. The ground illumination device of claim 8, wherein the 360-degree area of ground is an annulus.

10. The ground illumination device of claim 9, wherein the annulus has an inner radius of 1 foot and an outer radius ranging from 2 feet to 4 feet.

11. The ground illumination device of claim 10, wherein the inner radius is 1 foot and the outer radius is 2 feet.

12. The ground illumination device of claim 11, further comprising a power switch disposed on the outer surface.

13. The ground illumination device of claim 12, further comprising a motion detector in electronic communication with the power source.

14. The ground illumination device of claim 13, wherein the power source only operates the plurality of light sources when the motion detector detects motion.

15. The ground illumination device of claim 14, wherein one of the plurality of light sources is configured to display a graphical image.

16. The ground illumination device of claim 15, wherein the power source is rechargeable.

17. The ground illumination device of claim 16, wherein the harness is constructed out of a water-resistant material.
